(19) United States
(12) Patent Application Publication
(10) Pub. No.: US 2023/0311812 A1
(43) Pub. Date: Oct. 5, 2023

(54) CONTROL SYSTEM AND CONTROL METHOD OF CONTROL SYSTEM

(71) Applicant: HONDA MOTOR CO., LTD., Tokyo (JP)

(72) Inventor: Kenji Okuma, Tokyo (JP)

(21) Appl. No.: 18/181,055

(22) Filed: Mar. 9, 2023

(30) Foreign Application Priority Data
Mar. 30, 2022 (JP) 2022-056997

(51) Int. Cl. B60R 25/31; B60R 25/30; B60R 25/01; E05F 15/73

(52) U.S. Cl. CPC B60R 25/31; B60R 25/305; B60R 25/01; E05F 15/73; B60R 25/2045

(57) ABSTRACT

A control system includes: a vehicle outside image acquisition unit configured to acquire a vehicle outside image; a first detection unit configured to detect a vehicle outside person based on the vehicle outside image; a second detection unit configured to detect a predetermined motion of the detected vehicle outside person; a first authentication unit configured to authenticate whether or not the detected vehicle outside person is a registered user of the vehicle based on a predetermined part of the detected vehicle outside person; and a door control unit configured to perform door opening control of the vehicle. The door control unit performs the door opening control in a first mode based on the predetermined motion, when the detected predetermined motion is the predetermined motion of the vehicle outside person authenticated as the registered user.

### INCORPORATION BY REFERENCE

The present application claims priority under 35 U.S.C.§ 119 to Japanese Patent Application No. 2022-056997 filed on Mar. 30, 2022. The content of the application is incorporated herein by reference in its entirety.

### BACKGROUND OF THE INVENTION

### Field of the Invention

The present invention relates to a control system and a control method of the control system.

### Description of the Related Art

In recent years, active efforts have been made to provide sustainable access to a transportation system while taking into consideration even vulnerable people such as aged people and children among traffic participants. Towards the realization, the focus is on research and development for further improving traffic safety and convenience through development regarding accessibility of a vehicle. Up to now, technology regarding control of a door of a vehicle is known as the technology that improves the convenience (for example, see Japanese Patent Laid-Open No. 2013-28903). Japanese Patent Laid-Open No. 2013-28903 discloses the technology of detecting a motion of a human body present in a predetermined range of a vehicle in a noncontact manner, determining a moving operation of a vehicle door based on the detected motion of the human body and controlling door driving means according to the determination.

According to Japanese Patent Laid-Open No. 2013-28903, since a user of a vehicle can open a door of the vehicle by a gesture, convenience of the user of the vehicle can be improved. However, a problem with Japanese Patent Laid-Open No. 2013-28903 is that even a third person can open the door of the vehicle by the gesture.

An object of the present invention, which has been made in consideration of circumstances described above, is to improve security of a vehicle while ensuring convenience of a user of the vehicle in the control of a door of the vehicle.

### SUMMARY OF THE INVENTION

An aspect of the present invention is a control system which is a vehicle control system, including: a vehicle outside image acquisition unit configured to acquire a vehicle outside image which is an image outside the vehicle; a first detection unit configured to detect a vehicle outside person present outside the vehicle based on the vehicle outside image acquired by the vehicle outside image acquisition unit; a second detection unit configured to detect a predetermined motion of the vehicle outside person detected by the first detection unit; a first authentication unit configured to authenticate whether or not the vehicle outside person detected by the first detection unit is a registered user who is a user of the vehicle registered beforehand, based on a predetermined part of the vehicle outside person detected by the first detection unit; and a door control unit configured to perform door opening control regarding opening of a door of the vehicle, wherein the door control unit performs the door opening control in a first mode based on the predetermined motion detected by the second detection unit when the predetermined motion detected by the second detection unit is the predetermined motion of the vehicle outside person authenticated as the registered user by the first authentication unit.

According to the aspect of the present invention, security of a vehicle can be improved while ensuring convenience of a user of the vehicle in the control of a door of the vehicle.

### BRIEF DESCRIPTION OF THE DRAWINGS

FIG. 1 is a diagram illustrating a configuration of a control system;

FIG. 2 is a diagram illustrating a configuration of a vehicle;

FIG. 3 is a diagram illustrating a main part configuration of the control system;

FIG. 4 is a diagram illustrating an example of each database stored in a second memory;

FIG. 5 is flowcharts illustrating operations of an entry ECU and a zone A-ECU;

FIG. 6 is a diagram for explaining an operation timing of the control system;

FIG. 7 is flowcharts illustrating the operations of the entry ECU and the zone A-ECU;

FIG. 8 is flowcharts illustrating the operations of the entry ECU and the zone A-ECU;

FIG. 9 is flowcharts illustrating the operations of the entry ECU and the zone A-ECU; and

FIG. 10 is flowcharts illustrating the operations of the entry ECU and the zone A-ECU.

### DETAILED DESCRIPTION OF THE PREFERRED EMBODIMENTS

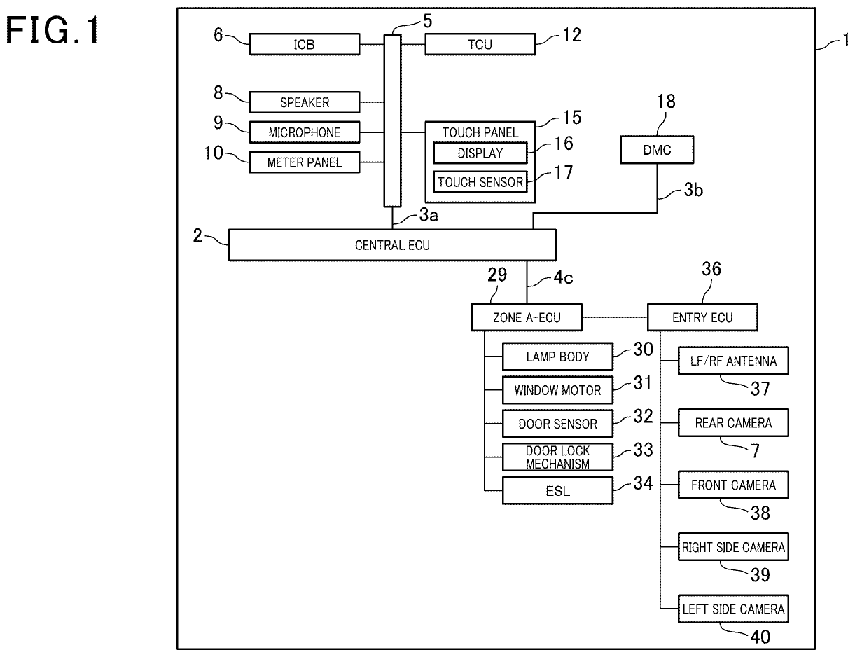

FIG. 1 is a diagram illustrating a control system 1 of a vehicle.

The control system 1 includes a central ECU 2 (processor, memory) which performs general control of the vehicle and information processing. The central ECU 2 is connected to communication lines including first communication lines 3a and 3b and a second communication lines 4c. The central ECU 2 realizes a function of a gateway which manages transfer of communication data among the communication lines. In addition, the central ECU 2 executes OTA (Over The Air) management. The OTA management includes control regarding processing of downloading an update program of an in-vehicle device provided in the vehicle from a server outside the vehicle and processing of applying the downloaded update program to the in-vehicle device.

The first communication lines 3a and 3b and the second communication line 4c are formed from buses for communication based on a standard of CAN, Ethernet (R) or the like, or the communication lines for P2P (Peer to Peer) communication. Note that the first communication lines 3a and 3b may be formed from the plurality of communication lines for the communication based on the same standard or may be formed from the plurality of communication lines for the communication based on the different standards. The same applies for the second communication line 4c.

To the first communication line 3a, an ICB (Infotainment Control Box) 6, a speaker 8, a microphone 9 and a meter panel 10 are connected via an in-vehicle connection link 5. The meter panel 10 displays information on an operation state of a vehicle including a vehicle speed.

In addition, to the in-vehicle connection link 5, a TCU (Telematics Control Unit) 12 and a touch panel 15 are connected. The TCU 12 is a wireless communication device (transmitter/receiver, circuit) based on a communication standard of a mobile communication system. The touch panel 15 includes a display 16 and a touch sensor 17.

The ICB 6 is an IVI (In-Vehicle Infotainment)-ECU (processor, memory). The ICB 6 provides passengers of the vehicle with various kinds of information and entertainments using the speaker 8, the microphone 9 and the touch panel 15 or the like.

The in-vehicle connection link 5 is formed from a plurality of communication transmission lines based on various communication standards. The in-vehicle connection link 5 may include a plurality of network transmission lines, for example. In this case, the plurality of network transmission lines may be connected to each other via a device having a gateway function or the like. In addition, the in-vehicle connection link 5 may include a transmission line for performing the P2P communication. For the network transmission lines, various kinds of communication buses for network communication based on various standards can be adopted. The standards of this kind are CAN, Ethernet, USB (Universal Serial Bus), LIN (Local Interconnect Network), and LVDS (Low Voltage Differential Signaling) for example, but may be other standards.

To the first communication line 3b, a DMC (Driver Monitoring Camera) 18 which monitors a driver is connected.

To the second communication line 4c, a zone A-ECU 29 is connected. The zone A-ECU 29 is connected to a lamp body 30 and a window motor 31. The lamp body 30 includes, for example, a head lamp, a tail lamp and a direction indicator lamp or the like. The window motor 31 opens and closes vehicle windows. In addition, the zone A-ECU 29 is connected to a door sensor 32, a door lock mechanism 33 and an ESL (Electronic Steering Lock) 34. The door sensor 32 detects an operation to a vehicle door. The door lock mechanism 33 locks and unlocks the vehicle door. To the zone A-ECU 29, an entry ECU 36 is connected. To the entry ECU 36, an LF/RF antenna 37 for wireless communication with an electronic key of the present vehicle is connected. The electronic key is an electronic device having a wireless communication function, and is referred to as a smart key or an FOB key. The entry ECU 36 cooperates with the other in-vehicle ECUs, processes user access from the outside of the vehicle to the control system 1, and realizes an operation of so-called smart entry.

To the entry ECU 36, a rear camera 7, a front camera 38, a right side camera 39 and a left side camera 40 are connected further.

Hereinafter, a sign “V” is attached for the vehicle including the control system 1.

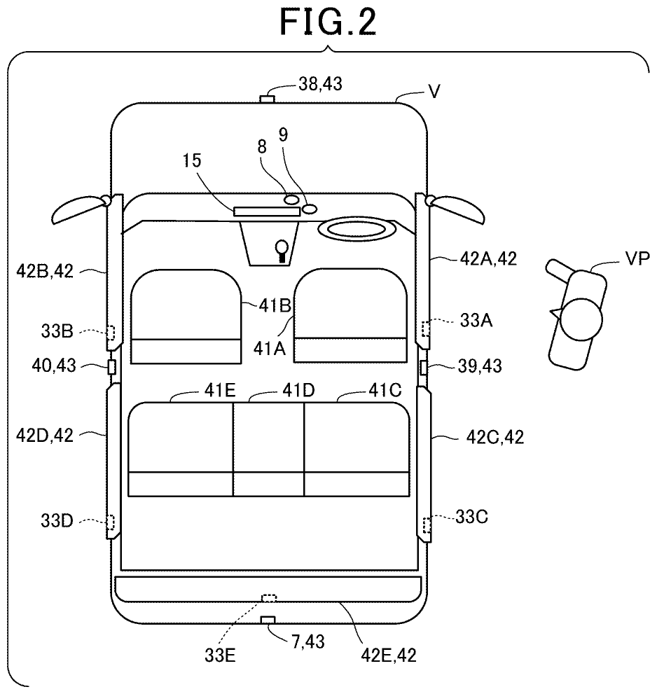

FIG. 2 is a diagram illustrating a configuration of a vehicle V.

The vehicle V illustrated in FIG. 2 is a four-wheel car with a riding capacity of five. The vehicle V includes a driver's seat 41A, a front passenger seat 41B, a rear right seat 41C, a rear center seat 41D and a rear left seat 41E.

The vehicle V includes a right front door 42A, a left front door 42B, a right rear door 42C, a left rear door 42D and a tail gate 42E. By opening the right front door 42A, the left front door 42B, the right rear door 42C and the left rear door 42D, entrance and exit to/from interior space of the vehicle V are made possible. The tail gate 42E opens and closes a trunk of the vehicle V.

In the following explanation, when the right front door 42A, the left front door 42B, the right rear door 42C, the left rear door 42D and the tail gate 42E are not to be distinguished, they are referred to as “doors” and a sign “42” is attached.

The vehicle V includes the door lock mechanism 33. The door lock mechanism 33 includes door lock mechanisms 33A, 33B, 33C, 33D and 33E.

The door lock mechanism 33A unlocks and locks the right front door 42A. The door lock mechanism 33B unlocks and locks the left front door 42B. The door lock mechanism 33C unlocks and locks the right rear door 42C. The door lock mechanism 33D unlocks and locks the left rear door 42D. The door lock mechanism 33E unlocks and locks the tail gate 42E.

On a front part of the vehicle V, the front camera 38 which captures an image of the front of the vehicle V is provided. On a rear part of the vehicle V, the rear camera 7 which captures an image of the rear of the vehicle V is provided. In addition, on a right side part of the vehicle V, the right side camera 39 which captures an image of a right side of the vehicle V is provided. Further, on a left side part of the vehicle V, the left side camera 40 which captures an image of a left side of the vehicle V is provided. The front camera 38, the rear camera 7, the right side camera 39 and the left side camera 40 are vehicle outside cameras which capture an image of the outside of the vehicle V. In the following explanation, when the front camera 38, the rear camera 7, the right side camera 39 and the left side camera 40 are not to be distinguished, they are referred to as “cameras” and a sign “43” is attached. The cameras 43 capture moving images of the outside of the vehicle V. The moving images captured by the cameras 43 include vehicle outside images which are the images outside the vehicle V.

The cameras 43 correspond to a “vehicle outside image acquisition unit” of the present disclosure.

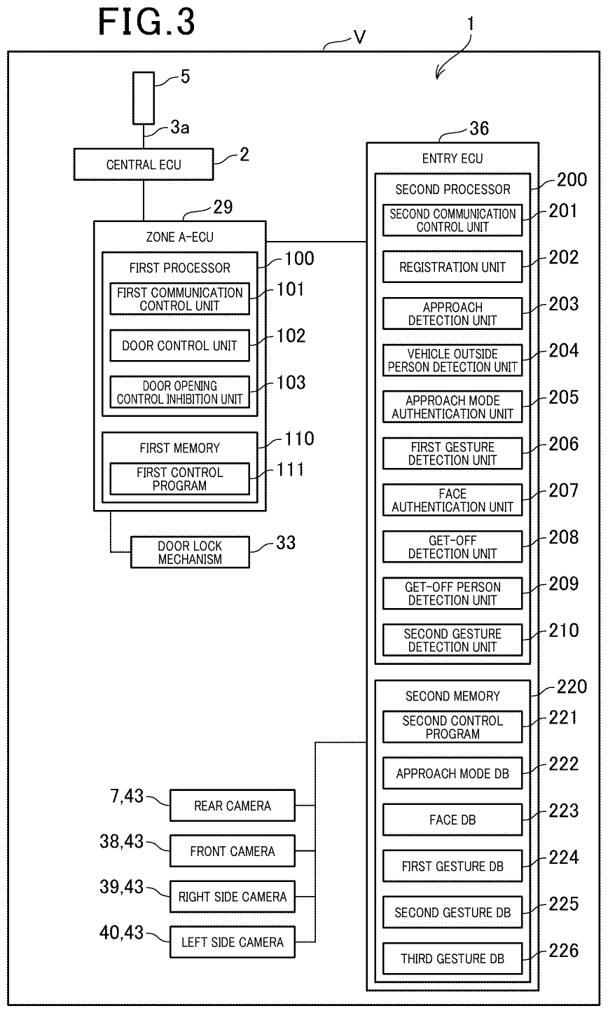

FIG. 3 is a diagram illustrating a main part configuration of the control system 1.

To the zone A-ECU 29, the central ECU 2 is connected. In addition, to the zone A-ECU 29, the door lock mechanism 33 and the entry ECU 36 are connected. To the entry ECU 36, the rear camera 7, the front camera 38, the right side camera 39 and the left side camera 40 are connected.

The zone A-ECU 29 includes a first processor 100 such as a CPU (Central Processing Unit) and an MPU (Micro Processor Unit), a first memory 110, and an interface circuit to which devices and apparatuses such as a sensor are connected.

The first memory 110 is a storage device which stores a program to be executed by the first processor 100 and data in a nonvolatile manner. The first memory 110 is formed from a magnetic storage device, a semiconductor storage element such as a flash ROM (Read Only Memory), or a nonvolatile storage device of the other kind. In addition, the first memory 110 may include a RAM (Random Access Memory) configuring a work area of the first processor 100. Further, the first memory 110 may include a nonvolatile storage device such as an HDD (Hard Disk Drive) and an SSD (Solid State Drive). The first memory 110 stores the data to be processed by the first processor 100 and a first control program 111 to be executed by the first processor 100.

The first processor 100 functions as a first communication control unit 101, a door control unit 102 and a door opening control inhibition unit 103 by reading and executing the first control program 111 stored in the first memory 110.

The first communication control unit 101 receives door control contents information J2 from the entry ECU 36. The door control contents information J2 is information indicating control contents regarding the doors 42.

The door control unit 102 performs door opening control. The door opening control is control regarding opening of the door 42, and is the control including unlocking of the door 42 and an opening operation of the door 42. In the present embodiment, the unlocking of the door 42 is exemplified as the door opening control. The door control unit 102 makes a control target door 42 be different and performs the door opening control according to the control contents of the door control contents information J2 received by the first communication control unit 101. Note that, in the door opening control, the door control unit 102 outputs an unlocking signal to the door lock mechanism 33 corresponding to the control target door 42.

The door control unit 102 performs door closing control. The door closing control is the control regarding closing of the door 42, and is the control including locking of the door 42 and a closing operation of the door 42. In the present embodiment, the locking of the door 42 is exemplified as the door closing control. The door control unit 102 makes the control target door 42 be different and performs the door closing control according to the control contents of the door control contents information J2 received by the first communication control unit 101. In the door closing control, the door control unit 102 outputs a locking signal to the door lock mechanism 33.

The door opening control inhibition unit 103 makes the door control unit 102 inhibit execution of the door opening control. When the first communication control unit 101 receives specified door control contents information J2, the door opening control inhibition unit 103 makes the door control unit 102 inhibit the execution of the door opening control. The door opening control inhibition unit 103 makes the door control unit 102 inhibit the execution of the door opening control by outputting inhibition information to the door control unit 102. When the inhibition information is received from the door opening control inhibition unit 103, the door control unit 102 does not execute the door opening control even when the first communication control unit 101 receives the door control contents information J2. When a predetermined trigger such as the unlocking of the door 42 by the electronic key is generated, the door opening control inhibition unit 103 cancels inhibition of the execution of the door opening control. The door opening control inhibition unit 103 cancels the inhibition of the execution of the door opening control by the door control unit 102 by outputting cancellation information to the door control unit 102. When the cancellation information is received from the door opening control inhibition unit 103, the door control unit 102 restarts the execution of the door opening control.

The entry ECU 36 includes a second processor 200 such as a CPU and an MPU, a second memory 220 and an interface circuit to which devices and apparatuses such as a sensor are connected. To the entry ECU 36, moving image data is inputted from the cameras 43. The moving image data is the data of the moving images captured by the cameras 43.

The second memory 220 is a storage device which stores a program to be executed by the second processor 200 and data in the nonvolatile manner. The second memory 220 is formed from a magnetic storage device, a semiconductor storage element such as a flash ROM, or a nonvolatile storage device of the other kind. In addition, the second memory 220 may include a RAM configuring a work area of the second processor 200. Further, the second memory 220 may include a nonvolatile storage device such as an HDD and an SSD. The second memory 220 stores the data to be processed by the second processor 200, a second control program 221 to be executed by the second processor 200, an approach mode DB 222, a face DB 223, a first gesture DB 224, a second gesture DB 225 and a third gesture DB 226 or the like.

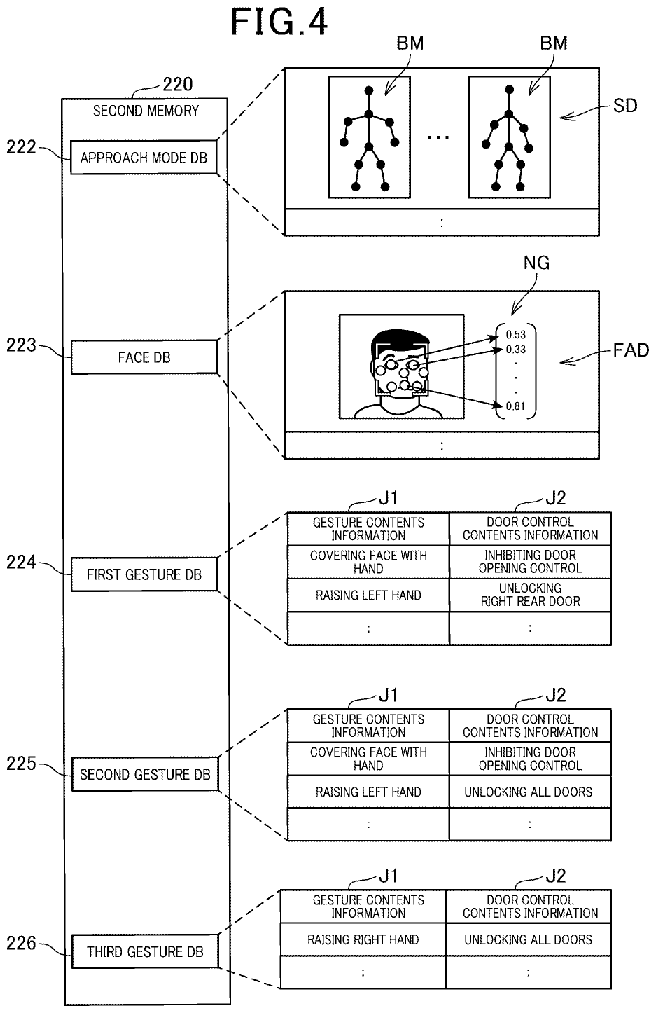

With reference to FIG. 4, each database stored in the second memory 220 will be explained.

FIG. 4 is a diagram illustrating an example of each database stored in the second memory 220.

In the approach mode DB 222, information of how a user approaches the vehicle V (hereinafter, referred to as an “approach mode”) is recorded for each user of the vehicle V. One record in the approach mode DB 222 includes approach mode data SD. The approach mode data SD is the data for which a build models BM of the user of the vehicle V when approaching the vehicle V are time-sequentially lined up. The build model BM is a model simulating a figure of a person by indicating the position of a head, the positions of shoulders, the positions of elbows, the position of a waist, the positions of knees and the positions of ankles by dots and connecting the individual dots by lines.

In the face DB 223, information regarding a face is recorded for each user of the vehicle V. One record in the face DB 223 includes face feature amount data FAD indicating a face feature amount. The face feature amount is a numerical value group NG for which a feature point is converted into a numerical value for each feature point of the face. Examples of the feature points are positions of eyes to a contour of the face, the position of a nose to the contour of the face and the position of a mouth to the contour of the face.

The face corresponds to a “predetermined part” of the present disclosure.

In the first gesture DB 224, information relating to a gesture is recorded for each gesture. One record that the first gesture DB 224 has includes gesture contents information J1 and the door control contents information J2. The gesture contents information J1 is information indicating gesture contents which are contents of the gesture.

In the example in FIG. 4, in the first gesture DB 224, with the gesture contents information J1 indicating the gesture contents of “covering the face with hands”, the door control contents information J2 indicating the control contents of “inhibiting the door opening control” is associated. In addition, in the example in FIG. 4, in the first gesture DB 224, with the gesture contents information J1 indicating the gesture contents of “raising a left hand”, the door control contents information J2 indicating the control contents of “unlocking the right rear door” is associated.

The gesture corresponds to a “predetermined motion” of the present disclosure.

In the second gesture DB 225, the information relating to the gesture is recorded for each gesture. Between the second gesture DB 225 and the first gesture DB 224, except for the gesture contents of “covering the face with hands”, the door control contents associated with the gesture contents are different. One record that the second gesture DB 225 has includes the gesture contents information J1 and the door control contents information J2.

In the example in FIG. 4, in the second gesture DB 225, with the gesture contents information J1 indicating the gesture contents of “covering the face with hands”, the door control contents information J2 indicating the control contents of “inhibiting the door opening control” is associated. In addition, in the example in FIG. 4, in the second gesture DB 225, with the gesture contents information J1 indicating the gesture contents of “raising a left hand”, the door control contents information J2 indicating the control contents of “unlocking all the doors” is associated.

In the third gesture DB 226, the information relating to the gesture is recorded for each gesture. In the third gesture DB 226, differently from the first gesture DB 224 and the second gesture DB 225, the door control contents information J2 indicating the control contents regarding the door closing control is recorded. That is, in the first gesture DB 224 and the second gesture DB 225, the door control contents information J2 indicating the control contents regarding the door opening control is recorded. One record that the third gesture DB 226 has includes the gesture contents information J1 and the door control contents information J2.

In the example in FIG. 4, in the third gesture DB 226, with the gesture contents information J1 indicating the gesture contents of “raising a right hand”, the door control contents information J2 indicating the control contents of “locking all the doors” is associated.

Returning to the explanation of FIG. 3, the second processor 200 functions as a second communication control unit 201, a registration unit 202, an approach detection unit 203, a vehicle outside person detection unit 204, an approach mode authentication unit 205, a first gesture detection unit 206, a face authentication unit 207, a get-off detection unit 208, a get-off person detection unit 209 and a second gesture detection unit 210 by reading and executing the second control program 221 stored in the second memory 220.

The vehicle outside person detection unit 204 corresponds to a “first detection unit” of the present disclosure. The approach mode authentication unit 205 corresponds to a “second authentication unit” of the present disclosure. The first gesture detection unit 206 corresponds to a “second detection unit” of the present disclosure. The face authentication unit 207 corresponds to a “first authentication unit” of the present disclosure. The get-off person detection unit 209 corresponds to a “third detection unit” of the present disclosure. The second gesture detection unit 210 corresponds to a “fourth detection unit” of the present disclosure.

The second communication control unit 201 communicates with the zone A-ECU 29.

The registration unit 202 records the approach mode data SD of the user of the vehicle V in the approach mode DB 222. The registration unit 202 generates the build model BM for each vehicle outside image of the moving images captured by the cameras 43, generates the approach mode data SD for which the generated build models are time-sequentially lined up, and records the approach mode data SD in the approach mode DB 222. Note that the build model BM is generated by existing build detection or technology of the existing build detection. Since the registration unit 202 records the approach mode data SD in the approach mode DB 222 in this way, the user of the vehicle V can register his/her own approach posture to the vehicle V by making the cameras 43 capture his/her own approach posture.

The registration unit 202 records the face feature amount data FAD of the user of the vehicle V in the face DB 223. The registration unit 202 generates the face feature amount data FAD from the moving images captured by the cameras 43 and records the face feature amount data FAD in the face DB 223. Since the registration unit 202 records the face feature amount data FAD in the face DB 223 in this way, the user of the vehicle V can register his/her own face to the vehicle V by making the cameras 43 capture an image of his/her own face.

The registration unit 202 records a combination of the gesture contents and the control contents in the first gesture DB 224. The registration unit 202 recognizes the gesture contents of the gesture performed by the user of the vehicle V from the moving images captured by the cameras 43 by a method of image analysis or the like. Then, the registration unit 202 associates the door control contents information J2 indicating the control contents specified by the user of the vehicle V with the gesture contents information J1 indicated by the recognized gesture contents and records the information in the first gesture DB 224. The registration unit 202 records the combination of the gesture contents and the control contents in the first gesture DB 224 in this way so that the user of the vehicle V can register a desired gesture for having desired door opening control be performed to the vehicle V. The registration unit 202 records the combination of the gesture contents and the control contents similarly for the second gesture DB 225 and the third gesture DB 226.

The approach detection unit 203 detects approach of a person to the vehicle V. For example, the approach detection unit 203 detects the approach of a person to the vehicle V based on a detection value of a sonar sensor provided in the vehicle V. In addition, for example, the approach detection unit 203 detects the approach of a person to the vehicle V by detection of the electronic key using the LF/RF antenna 37. Note that a detection method of the approach detection unit 203 is just an example and is not limited to the examples described above. The cameras 43 of the present embodiment are activated and start capturing when the approach detection unit 203 detects the approach of a person to the vehicle V. The approach detection unit 203 may activate the cameras 43 at all times and detect the approach of a person to the vehicle V from a captured result of the cameras 43. In addition, the approach detection unit 203 may detect the approach by using other sensors such as an NIR (Near InfraRed) sensor (not illustrated) in combination.

The vehicle outside person detection unit 204 detects a vehicle outside person VP present outside the vehicle V based on the vehicle outside image of the moving images captured by the cameras 43. Specifically, the vehicle outside person detection unit 204 detects the vehicle outside person VP by detecting an image of the vehicle outside person VP from the vehicle outside image by a method of pattern matching or the like.

The approach mode authentication unit 205 authenticates whether or not the vehicle outside person VP detected by the vehicle outside person detection unit 204 is a registered user, based on the approach mode of the vehicle outside person VP detected by the vehicle outside person detection unit 204. The registered user is a person registered to the vehicle V as the user of the vehicle V.

The approach mode authentication unit 205 generates the approach mode data SD for the vehicle outside person VP detected by the vehicle outside person detection unit 204. Specifically, the approach mode authentication unit 205 generates the build model BM of the vehicle outside person VP detected by the vehicle outside person detection unit 204 for each vehicle outside image of the moving images captured by the cameras 43 and generates the approach mode data SD for which the generated build models are time-sequentially lined up.

The approach mode authentication unit 205 compares a time change of the build model BM indicated by the generated approach mode data SD and a time change of the build model BM indicated by the approach mode data SD in the approach mode DB 222. When the approach mode DB 222 stores the approach mode data SD whose concordance rate with the time change of the generated build model BM is at a predetermined or higher, the approach mode authentication unit 205 authenticates that the vehicle outside person VP detected by the vehicle outside person detection unit 204 is the registered user. On the other hand, when the approach mode DB 222 does not store the approach mode data SD whose concordance rate with the time change of the generated build model BM is at the predetermined or higher, the approach mode authentication unit 205 authenticates that the vehicle outside person VP detected by the vehicle outside person detection unit 204 is not the registered user.

The first gesture detection unit 206 detects the gesture of the vehicle outside person VP detected by the vehicle outside person detection unit 204. For more details, the first gesture detection unit 206 detects the gesture of the vehicle outside person VP authenticated as the registered user by the approach mode authentication unit 205 after the authentication by the approach mode authentication unit 205. In addition, the first gesture detection unit 206 detects the gesture of the vehicle outside person VP authenticated as the registered user by the face authentication unit 207 after the authentication by the face authentication unit 207. The first gesture detection unit 206 tracks the image of the vehicle outside person VP authenticated as the registered user in the moving images captured by the cameras 43. The first gesture detection unit 206 performs the image analysis on the image of the vehicle outside person VP being tracked, and extracts a characteristic (a motion vector, for example) of a motion of the vehicle outside person VP. Then, the first gesture detection unit 206 recognizes motion contents of the vehicle outside person VP from the extracted characteristic of the motion of the vehicle outside person VP. Then, when the recognized motion contents of the vehicle outside person VP are the gesture contents recorded in the first gesture DB 224 and the second gesture DB 225, the first gesture detection unit 206 determines that the gesture of the vehicle outside person VP has been detected.

The first gesture detection unit 206 detects the gesture of a non-registered user who is a user of the vehicle V other than the registered user in a case to be described later. The first gesture detection unit 206 tracks the image of the vehicle outside person VP who is the non-registered user in the moving images captured by the cameras 43. The first gesture detection unit 206 performs the image analysis on the image of the vehicle outside person VP being tracked, and extracts the characteristic of the motion of the vehicle outside person VP. Then, the first gesture detection unit 206 recognizes the motion contents of the vehicle outside person VP from the extracted characteristic of the motion of the vehicle outside person VP. Then, when the recognized motion contents of the vehicle outside person VP are the gesture contents recorded in the first gesture DB 224 and the second gesture DB 225, the first gesture detection unit 206 determines that the gesture of the non-registered user has been detected.

The face authentication unit 207 authenticates whether or not the vehicle outside person VP authenticated as the registered user by the approach mode authentication unit 205 is the registered user. That is, the control system 1 of the present embodiment performs two-factor authentication. The face authentication unit 207 authenticates whether or not the vehicle outside person VP is the registered user based on the face of the vehicle outside person VP. The face authentication unit 207 extracts the image of the face of the vehicle outside person VP from the moving images captured by the cameras 43, and calculates the face feature amount from the extracted image of the face. The face authentication unit 207 compares the calculated face feature amount and the face feature amount indicated by the face feature amount data FAD recorded in the face DB 223, and determines whether or not the face feature amount data FAD whose concordance rate with the calculated face feature amount is at a threshold or higher is included in the face DB 223. When it is determined that the face feature amount data FAD whose concordance rate with the calculated face feature amount is at the threshold or higher is included in the face DB 223, the face authentication unit 207 authenticates that the vehicle outside person VP authenticated as the registered user by the approach mode authentication unit 205 is the registered user. On the other hand, when it is determined that the face feature amount data FAD whose concordance rate with the calculated face feature amount is at the threshold or higher is not included in the face DB 223, the face authentication unit 207 authenticates that the vehicle outside person VP authenticated as the registered user by the approach mode authentication unit 205 is not the registered user.

The get-off detection unit 208 detects whether or not a passenger has gotten off the vehicle V. For example, when an ignition power source of the vehicle V is turned off and then the door 42 is turned to an open state, the get-off detection unit 208 detects that the passenger has gotten off the vehicle V. Note that the detection method of the get-off detection unit 208 is just an example and is not limited to the example described above.

The get-off person detection unit 209 detects a get-off person, who is a person who has gotten off the vehicle V. The get-off person detection unit 209 detects the vehicle outside person VP who has gotten off the vehicle V and is moving away from the vehicle V as the get-off person. For example, the get-off person detection unit 209 detects the vehicle outside person VP whose image area is smaller than a value equal to or larger than the predetermined value as the get-off person, among the vehicle outside persons VP projected in the moving images captured by the cameras 43.

The second gesture detection unit 210 detects the gesture of the get-off person detected by the get-off person detection unit 209. The second gesture detection unit 210 tracks the image of the get-off person detected by the get-off person detection unit 209 in the moving images captured by the cameras 43. The second gesture detection unit 210 performs the image analysis on the image of the get-off person being tracked, and extracts the characteristic of the motion of the get-off person. Then, the second gesture detection unit 210 recognizes the motion contents of the get-off person from the extracted characteristic of the motion of the get-off person. Then, when the recognized motion contents of the get-off person are the gesture contents recorded in the third gesture DB 226, the second gesture detection unit 210 determines that the gesture of the get-off person has been detected.

Next, operations of the individual units of the control system 1 will be explained.

First, the operation of the control system 1 when the vehicle outside person detection unit 204 detects one vehicle outside person VP will be explained.

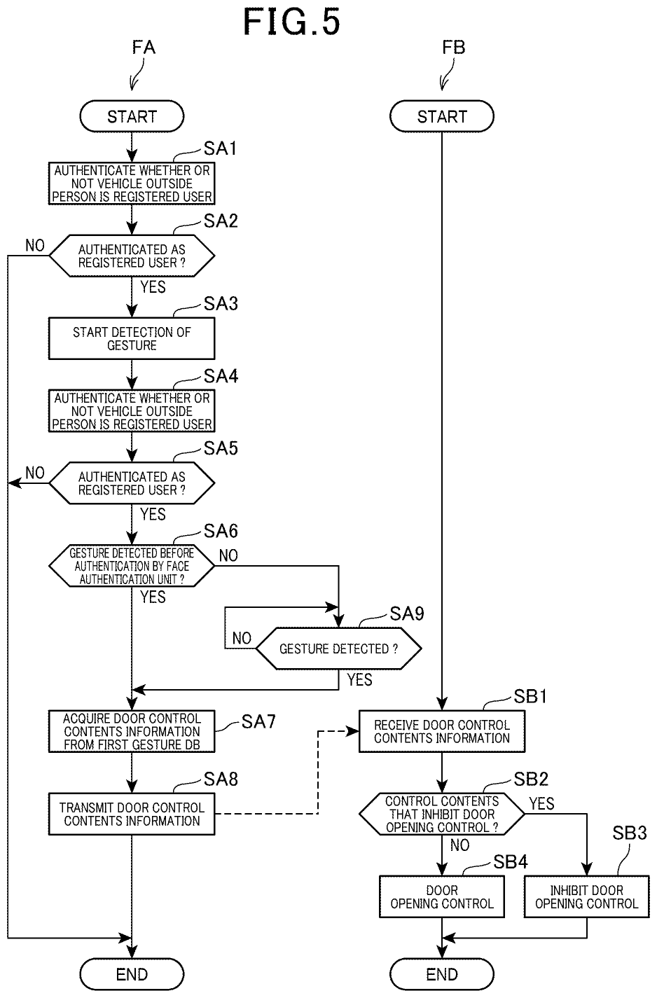

FIG. 5 is flowcharts illustrating the operations of the entry ECU 36 and the zone A-ECU 29. In FIG. 5, a flowchart FA illustrates the operation of the entry ECU 36, and a flowchart FB illustrates the operation of the zone A-ECU 29.

As illustrated in the flowchart FA, the approach mode authentication unit 205 authenticates whether or not the vehicle outside person VP detected by the vehicle outside person detection unit 204 is the registered user (step SA1).

Next, the first gesture detection unit 206 determines whether or not it has been authenticated that the vehicle outside person VP is the registered user in step SA1 (step SA2). When it is determined that it has been authenticated that the vehicle outside person VP is not the registered user (step SA2: NO), the second processor 200 ends the present processing.

On the other hand, when it is determined that it has been authenticated the vehicle outside person VP is the registered user (SA2: YES), the first gesture detection unit 206 starts the detection of the gesture (step SA3).

Then, the face authentication unit 207 authenticates whether or not the vehicle outside person VP authenticated as the registered user by the approach mode authentication unit 205 is the registered user (step SA4).

Next, the first gesture detection unit 206 determines whether or not it has been authenticated that the vehicle outside person VP is the registered user in step SA4 (step SA5).

When the first gesture detection unit 206 determines that it has been authenticated that the vehicle outside person VP is not the registered user (step SA5: NO), the second processor 200 ends the present processing.

On the other hand, when it is determined that it has been authenticated that the vehicle outside person VP is the registered user (step SA5: YES), the first gesture detection unit 206 determines whether or not the gesture has been detected before the authentication by the face authentication unit 207 (step SA6).

When it is determined that the gesture has been detected before the authentication by the face authentication unit 207 (step SA6: YES), the first gesture detection unit 206 acquires the door control contents information J2 corresponding to the detected gesture from the first gesture DB 224 (step SA7).

Next, the second communication control unit 201 transmits the door control contents information J2 acquired in step SA7 to the zone A-ECU 29 (step SA8). Returning to the explanation of step SA6, when it is determined that the gesture has not been detected before the authentication by the face authentication unit 207 (step SA6: NO), the first gesture detection unit 206 determines whether or not the gesture has been detected (step SA9). When affirmative determination is not made within a predetermined period after the determination in step SA9 is started, the second processor 200 may end the present processing.

When it is determined that the gesture has been detected (step SA9: YES), the first gesture detection unit 206 acquires the door control contents information J2 corresponding to the detected gesture from the first gesture DB 224 (step SA7).

Then, the second communication control unit 201 transmits the door control contents information J2 acquired in step SA7 to the zone A-ECU 29 (step SA8).

As illustrated in the flowchart FB, the first communication control unit 101 of the zone A-ECU 29 receives the door control contents information J2 from the entry ECU 36 (step SB1).

The first communication control unit 101 determines whether or not the control contents indicated by the received door control contents information J2 are the contents that inhibit the door opening control (step SB2). Note that the door control contents information J2 of the contents that inhibit the door opening control is, in the example in FIG. 4, the door control contents information J2 indicating the control contents of “inhibiting the door opening control”.

When the first communication control unit 101 determines that the control contents indicated by the door control contents information J2 are the contents that inhibit the door opening control (step SB2: YES), the door opening control inhibition unit 103 makes the execution of the door opening control be inhibited (step SB3).

On the other hand, when the first communication control unit 101 determines that the control contents indicated by the door control contents information J2 are not the contents that inhibit the door opening control (step SB2: NO), the door control unit 102 performs the door opening control according to the control contents indicated by the door control contents information J2 received in step SB1 (step SB4).

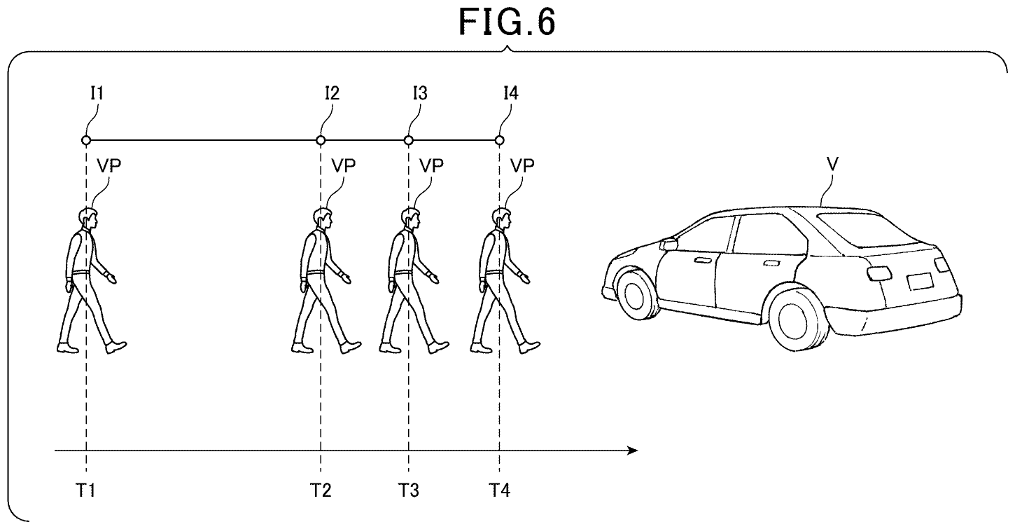

Next, an operation timing of the control system 1 will be explained with reference to FIG. 6.

FIG. 6 is a diagram for explaining the operation timing of the control system 1.

FIG. 6 illustrates the case where the vehicle outside person VP who is the registered user unlocks the door 42 of the vehicle V by the gesture and tries to get into the vehicle V. In addition, FIG. 6 illustrates the case where the first gesture detection unit 206 detects the gesture of the vehicle outside person VP before the authentication by the face authentication unit 207.

In FIG. 6, four positions I1, I2, I3 and I4 are illustrated. The position I1 is the position farthest from the vehicle V among the positions I1, I2, I3 and I4. The position I2 is the position closer to the vehicle V than the position I1 and farther from the vehicle V than the positions I3 and I4. The position I3 is the position closer to the vehicle V than the positions I1 and I2 and farther from the vehicle V than the position I4. The position I4 is the position closest to the vehicle V among the positions I1, I2, I3 and I4.

In FIG. 6, the approach detection unit 203 detects the approach of the vehicle outside person VP at a timing T1. Note that, in FIG. 6, the vehicle outside person VP is positioned at the position I1 at the timing T1. When the approach detection unit 203 detects the approach of the vehicle outside person VP at the timing T1, the vehicle outside person detection unit 204 detects the vehicle outside person VP after the timing T1.

In FIG. 6, the approach mode authentication unit 205 authenticates that the vehicle outside person VP is the registered user at a timing T2. Note that, in FIG. 6, the vehicle outside person VP is positioned at the position I2 at the timing T2. When the approach mode authentication unit 205 authenticates that the vehicle outside person VP is the registered user at the timing T2, the first gesture detection unit 206 detects the gesture after the timing T2.

In FIG. 6, the first gesture detection unit 206 detects the gesture of the vehicle outside person VP at a timing T3. Note that, in FIG. 6, the vehicle outside person VP is positioned at the position I3 at the timing T3.

In FIG. 6, the face authentication unit 207 authenticates that the vehicle outside person VP is the registered user at a timing T4. Note that, in FIG. 6, the vehicle outside person VP is positioned at the position I4 at the timing T4. When the face authentication unit 207 authenticates that the vehicle outside person VP is the registered user at the timing T4, at the timing T4, the door control unit 102 performs the door opening control corresponding to the gesture detected at the timing T3.

Next, the operations of the individual units of the control system 1 when the vehicle outside person detection unit 204 detects the plurality of vehicle outside persons VP will be explained.

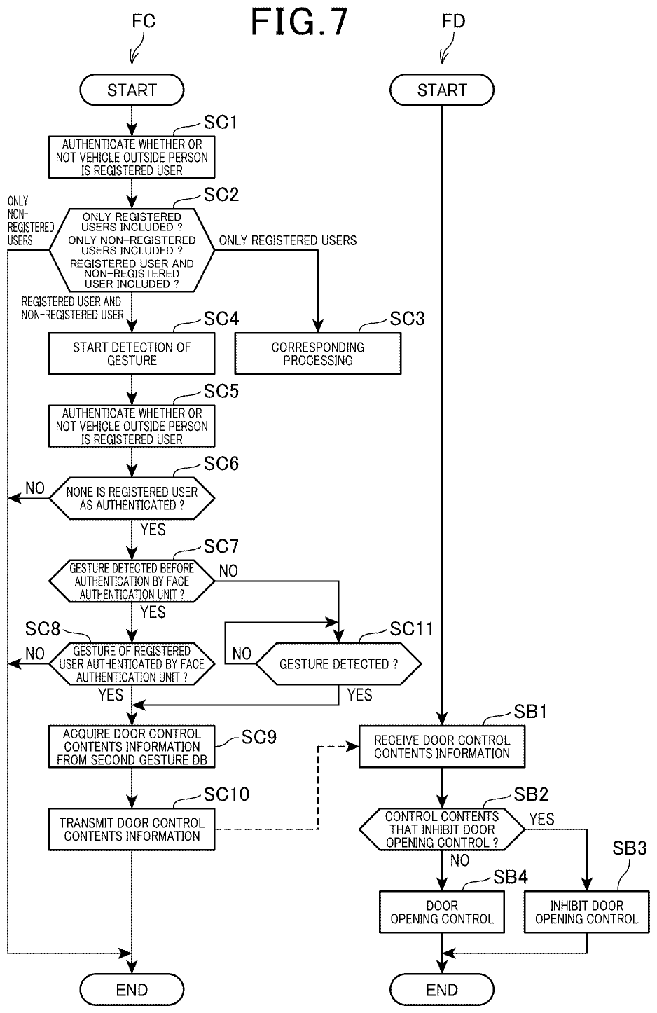

FIG. 7 is flowcharts illustrating the operations of the entry ECU 36 and the zone A-ECU 29. In FIG. 7, a flowchart FC illustrates the operation of the entry ECU 36, and a flowchart FD illustrates the operation of the zone A-ECU 29. In the flowcharts in FIG. 7, a same step number is attached for a step same as FIG. 5 and the detailed explanation is omitted.

As illustrated in the flowchart FC, the approach mode authentication unit 205 authenticates whether or not each of the vehicle outside persons VP detected by the vehicle outside person detection unit 204 is the registered user (step SC1).

Next, the approach mode authentication unit 205 determines whether the plurality of vehicle outside persons VP detected by the vehicle outside person detection unit 204 include only the registered users, include only the non-registered users or include the registered user and the non-registered user, based on an authentication result in step SC1 (step SC2).

When it is determined that only the non-registered users are included (step SC2: only non-registered users), the second processor 200 ends the present processing.

When it is determined that only the registered users are included (step SC2: only the registered users), the second processor 200 performs corresponding processing (step SC3). Here, the corresponding processing is the processing of step SA3-step SA8 explained in FIG. 5.

When it is determined that the registered users and the non-registered users are included (step SC2: the registered users and the non-registered users), the first gesture detection unit 206 starts the detection of the gesture of the registered user (step SC4).

The face authentication unit 207 authenticates whether or not the vehicle outside persons VP authenticated as the registered users by the approach mode authentication unit 205 are the registered users (step SC5).

Then, the first gesture detection unit 206 determines whether or not none of vehicle outside persons VP under authentication is the registered user as authenticated in step SC5 (step SC6).

When it is determined that none of the vehicle outside persons VP under authentication is the registered user as authenticated (step SC6: NO), the second processor 200 ends the present processing.

On the other hand, when it is determined that it has been authenticated that at least some of all the vehicle outside persons VP under authentication are the registered users (step SC6: YES), the first gesture detection unit 206 determines whether or not the gesture has been detected before the authentication by the face authentication unit 207 (step SC7).

When it is determined that the gesture has been detected before the authentication by the face authentication unit 207 (step SC7: YES), the first gesture detection unit 206 determines whether or not the detected gesture is the gesture of the registered user authenticated by the face authentication unit 207 (step SC8).

When it is determined that the detected gesture is not the gesture of the registered user authenticated by the face authentication unit 207 (step SC8: NO), the second processor 200 ends the present processing.

On the other hand, when it is determined that the detected gesture is the gesture of the registered user authenticated by the face authentication unit 207 (step SC8: YES), the first gesture detection unit 206 acquires the door control contents information J2 corresponding to the detected gesture from the second gesture DB 225 (step SC9).

Then, the second communication control unit 201 transmits the door control contents information J2 acquired in step SC9 to the zone A-ECU 29 (step SC10).

Returning to the explanation of step SC7, when it is determined that the gesture has not been detected before the authentication by the face authentication unit 207 (step SC7: NO), the first gesture detection unit 206 determines whether or not the gesture has been detected (step SC11). Note that, when the affirmative determination is not made within the predetermined period after the determination in step SC11 is started, the second processor 200 may end the present processing.

When it is determined that the gesture has been detected (step SC11: YES), the first gesture detection unit 206 acquires the door control contents information J2 corresponding to the detected gesture from the second gesture DB 225 (step SC9).

Then, the second communication control unit 201 transmits the door control contents information J2 acquired in step SC9 to the zone A-ECU 29 (step SC10).

As above, when the plurality of vehicle outside persons VP detected by the vehicle outside person detection unit 204 include the registered user and the non-registered user, the entry ECU 36 transmits the door control contents information J2 acquired from the second gesture DB 225 to the zone A-ECU 29. On the other hand, when the vehicle outside persons VP detected by the vehicle outside person detection unit 204 are only the registered users, the entry ECU 36 transmits the door control contents information J2 acquired from the first gesture DB 224 to the zone A-ECU 29. As described above, between the first gesture DB 224 and the second gesture DB 225, even when the gesture contents are the same, the door control contents associated with the gesture contents are different. Therefore, even when the gesture performed by the registered user is the same gesture, the door control unit 102 can make the mode of the door opening control be different depending on whether or not the non-registered user is present with the registered user. That is, the door control unit 102 can perform the door opening control in a first mode when the non-registered user is not present with the registered user, and perform the door opening control in a second mode when the non-registered user is present with the registered user.

Next, the operations of the individual units of the control system 1 when the door opening control is performed in response to the gesture of the registered user after the vehicle outside person detection unit 204 detects the plurality of vehicle outside persons VP including the registered users and the non-registered users will be explained. That is, the operations of the individual units of the control system 1 after steps SC10 and SB4 in FIG. 7 are performed will be explained.

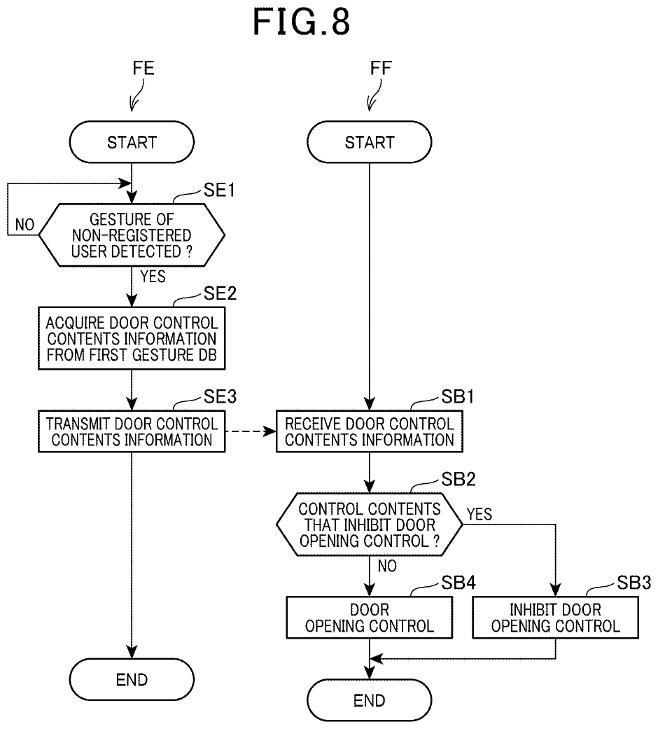

FIG. 8 is flowcharts illustrating the operations of the entry ECU 36 and the zone A-ECU 29. In FIG. 8, a flowchart FE illustrates the operation of the entry ECU 36, and a flowchart FF illustrates the operation of the zone A-ECU 29.

In the flowcharts in FIG. 8, the same step number is attached for the step same as FIG. 5 and the detailed explanation is omitted.

As illustrated in the flowchart FE, the first gesture detection unit 206 determines whether or not the gesture of the non-registered user has been detected (step SE1). Note that, when the affirmative determination is not made within the predetermined period after the determination in step SE1 is started, the second processor 200 may end the present processing.

When it is determined that the gesture of the non-registered user has been detected (step SE1: YES), the first gesture detection unit 206 acquires the door control contents information J2 corresponding to the detected gesture from the first gesture DB 224 (step SE2). Note that, in step SE2, the first gesture detection unit 206 may acquire the door control contents information J2 from the second gesture DB 225.

Then, the second communication control unit 201 transmits the door control contents information J2 acquired in step SE2 to the zone A-ECU 29 (step SE3).

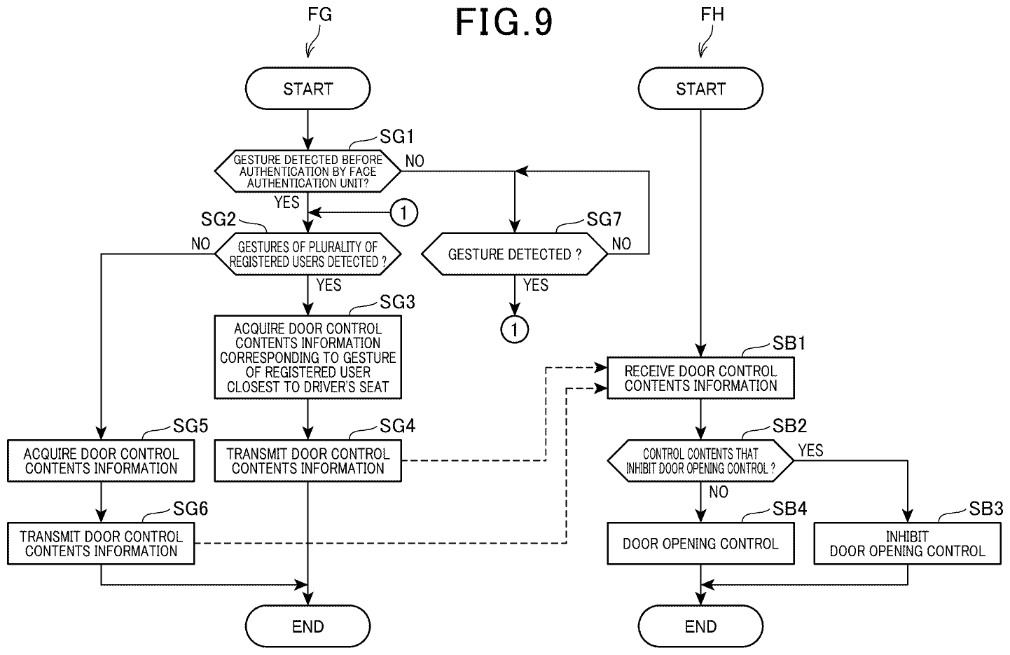

When the vehicle outside person detection unit 204 detects the plurality of vehicle outside persons VP including the plurality of registered users, there may be cases where each of the plurality of registered users performs the gesture simultaneously or at a short time interval. Then, when the vehicle outside person detection unit 204 detects the plurality of vehicle outside persons VP including the plurality of registered users, the control system 1 may execute the operations in FIG. 9.

FIG. 9 is flowcharts illustrating the operations of the entry ECU 36 and the zone A-ECU 29. In FIG. 9, a flowchart FG illustrates the operation of the entry ECU 36, and a flowchart FH illustrates the operation of the zone A-ECU 29.

In the flowcharts in FIG. 9, the same step number is attached for the step same as FIG. 5 and the detailed explanation is omitted.

At a point of time of start of the flowcharts illustrated in FIG. 9, the face authentication unit 207 authenticates that the two or more vehicle outside persons VP among the plurality of vehicle outside persons VP detected by the vehicle outside person detection unit 204 are the registered users.

As illustrated in the flowchart FG, the first gesture detection unit 206 determines whether or not the gesture has been detected before the authentication by the face authentication unit 207 (step SG1).

When it is determined that the gesture has been detected before the authentication by the face authentication unit 207 (step SG1: YES), the first gesture detection unit 206 determines whether or not the gestures of the plurality of registered users have been detected (step SG2).

When it is determined that the gestures of the plurality of registered users have been detected (step SG2: YES), the first gesture detection unit 206 acquires the door control contents information J2 corresponding to the gesture of the vehicle outside person VP closest to the driver's seat 41A among the detected gestures (step SG3). Here, the vehicle outside person VP closest to the driver's seat 41A is the vehicle outside person VP who is at a shortest distance to the vehicle V and located at the position closest to the driver's seat 41A in a front-back direction of the vehicle V. The first gesture detection unit 206 identifies the vehicle outside person VP closest to the driver's seat based on the image area of the vehicle outside person VP and the position of the vehicle outside person VP in the vehicle outside images captured by the cameras 43.

Note that, in step SG3, when all of the plurality of the vehicle outside persons VP detected by the vehicle outside person detection unit 204 are the registered users, the first gesture detection unit 206 acquires the door control contents information J2 from the first gesture DB 224. In addition, in step SG3, when some of the plurality of vehicle outside persons VP detected by the vehicle outside person detection unit 204 are the registered users, the first gesture detection unit 206 acquires the door control contents information J2 from the second gesture DB 225.

When the door control contents information J2 is acquired in step SG3, the second communication control unit 201 transmits the acquired door control contents information J2 to the zone A-ECU 29 (step SG4).

Returning to the explanation of step SG2, when it is determined that the gestures of the plurality of registered users have not been detected (step SG2: NO), the first gesture detection unit 206 acquires the door control contents information J2 corresponding to the detected gesture (step SG5).

Note that, in step SG5, when all of the plurality of the vehicle outside persons VP detected by the vehicle outside person detection unit 204 are the registered users, the first gesture detection unit 206 acquires the door control contents information J2 from the first gesture DB 224. In addition, in step SG5, when some of the plurality of vehicle outside persons VP detected by the vehicle outside person detection unit 204 are the registered users, the first gesture detection unit 206 acquires the door control contents information J2 from the second gesture DB 225.

Next, the second communication control unit 201 transmits the door control contents information J2 acquired in step SG5 to the zone A-ECU 29 (step SG6).

Returning to the explanation of the step SG1, when it is determined that the gesture has not been detected before the authentication by the face authentication unit 207 (step SG1: NO), the first gesture detection unit 206 determines whether or not the gesture has been detected (step SG7). Note that, when the affirmative determination is not made within the predetermined period after the determination in step SG7 is started, the second processor 200 may end the present processing.

When it is determined that the gesture has been detected (step SG7: YES), the first gesture detection unit 206 shifts the processing to step SG2.

Next, the operations of the individual units of the control system 1 relating to the door closing control will be explained.

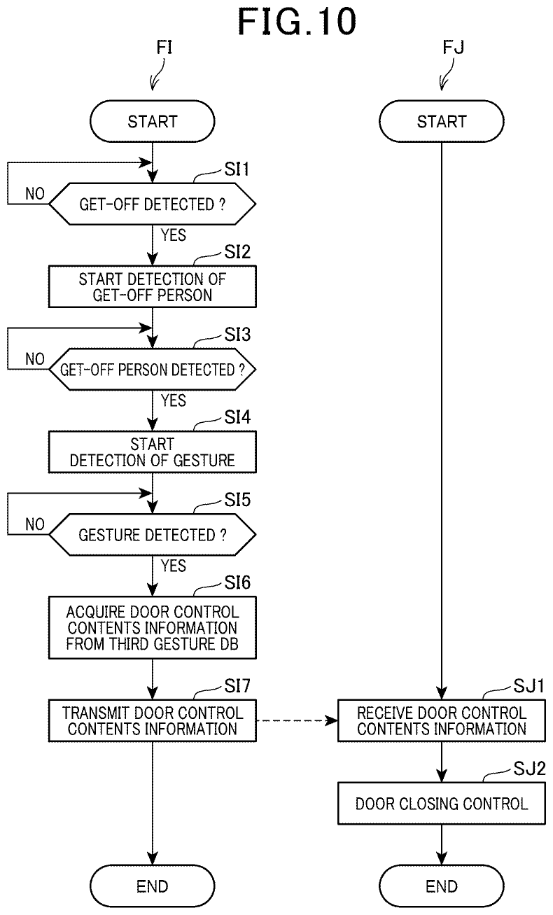

FIG. 10 is flowcharts illustrating the operations of the entry ECU 36 and the zone A-ECU 29.

In FIG. 10, a flowchart FI illustrates the operation of the entry ECU 36, and a flowchart FJ illustrates the operation of the zone A-ECU 29.

As illustrated in the flowchart FI, the get-off person detection unit 209 determines whether or not the get-off detection unit 208 has detected get-off of a passenger (step SI1).

When it is determined that the get-off detection unit 208 has detected the get-off of the passenger (step SI1: YES), the get-off person detection unit 209 starts the detection of the get-off person (step SI2).

Then, the second gesture detection unit 210 determines whether or not the get-off person detection unit 209 has detected the get-off person (step SI3). Note that, when the affirmative determination is not made within the predetermined period after the determination in step SI3 is started, the second processor 200 may end the present processing.

When it is determined that the get-off person detection unit 209 has detected the get-off person (step SI3: YES), the second gesture detection unit 210 starts the detection of the gesture of the get-off person (step SI4).

The second gesture detection unit 210 determines whether or not the gesture has been detected (step SI5). Note that, when the affirmative determination is not made within the predetermined period after the determination in step SI5 is started, the second processor 200 may end the present processing.

When it is determined that the gesture has been detected (step SI5: YES), the second gesture detection unit 210 acquires the door control contents information J2 corresponding to the gesture contents of the detected gesture from the third gesture DB 226 (step SI6).

Then, the second communication control unit 201 transmits the door control contents information J2 acquired in step SI6 to the zone A-ECU 29 (step SI7).

As illustrated in the flowchart FJ, the first communication control unit 101 of the zone A-ECU 29 receives the door control contents information J2 from the entry ECU 36 (step SJ1).

Next, the door control unit 102 performs the door closing control according to the door control contents indicated by the door control contents information J2 received in step SJ1 (step SJ2).

The embodiment described above illustrates just one mode, and arbitrary modifications and applications are possible.

The unlocking of the door 42 is exemplified as the door opening control in the embodiment described above. However, the door opening control is not limited to the unlocking of the door 42, and may be the opening operation of the door 42 when the door 42 is an electric door. Further, when the door 42 is an electric door and the door opening control is the opening operation of the door 42, the control system 1 may be configured such that the registered user can specify an opening degree of the door 42 according to the gesture.

The locking of the door 42 is exemplified as the door closing control in the embodiment described above. However, the door closing control is not limited to the locking of the door 42, and may be the closing operation of the door 42 when the door 42 is an electric door. Further, when the door 42 is an electric door and the door closing control is the closing operation of the door 42, the control system 1 may be configured such that the registered user can specify a closing degree of the door 42 according to the gesture.

In the other embodiments, when the approach mode authentication unit 205 authenticates that the vehicle outside person VP is the registered user, the zone A-ECU 29 may light the lamp body 30. The lamp body 30 to be lighted may be one or an arbitrary combination of the lights listed in the explanation of FIG. 1 or may be lights (the light which illuminates a ground surface facing a bottom surface of the vehicle V, for example) other than the lights listed in the explanation of FIG. 1.

In the embodiment described above, when the plurality of registered users perform the gestures, the gesture of the registered user closest to the driver's seat 41A is given priority. In the other embodiments, when the plurality of registered users perform the gestures and when the registered users do not compete for the control target door 42, a plurality of control operations corresponding to the gestures may be simultaneously performed.

The gesture is exemplified as the “predetermined motion” of the present disclosure in the embodiment described above. However, the “predetermined motion” of the present disclosure is not limited to the gesture, and may be a facial expression, for example.

The face is exemplified as the “predetermined part” of the present disclosure in the embodiment described above. However, the “predetermined part” of the present disclosure is not limited to the face, and may be a part configuring the face or a part other than the face such as a hand or a foot.

In the embodiment described above, the ECU including functional units of the door control unit 102 and the door opening control inhibition unit 103 is explained as the zone A-ECU 29. However, the ECU including the functional units may be the central ECU 2.

The first processor 100 and the second processor 200 may be formed from a plurality of processors, or may be formed from a single processor. The processors may be hardware programmed to realize the functional units described above. In this case, the processors are formed from an ASIC (Application Specific Integrated Circuit) and an FPGA (Field Programmable Gate Array), for example.

In addition, the configuration of the individual units of the control system 1 illustrated in FIG. 1 is an example, and a specific mounting form is not limited in particular. That is, hardware individually corresponding to the individual units is not necessarily mounted, and it is of course possible to realize the functions of the individual units by one processor executing the program. Further, in the embodiments described above, some of the functions realized by software may be hardware, or some of the functions realized by hardware may be realized by software.

In addition, step units of the operations illustrated in FIG. 5 and FIG. 7-FIG. 9 are divided according to main processing contents, and the present invention is not limited by a division method or names of processing units. Division into more step units may be performed according to the processing contents. Further, the division may be performed so that one step unit includes more processing. An order of the steps may be appropriately changed without obstructing the gist of the present invention.

Further, in the case of realizing a control method of the control system 1 described above using a processor, it is also possible to configure the program to be executed by the processor in a mode of a recording medium or a transmission medium which transmits the program. That is, the first control program 111 can be realized in the state of recording the first control program 111 in a portable information recording medium. Examples of the information recording medium are a magnetic recording medium such as a hard disk, an optical recording medium such as a CD and a semiconductor storage device such as a USB (Universal Serial Bus) memory and an SSD (Solid State Drive), and the other recording medium can be also used. In addition, the second control program 221 can be realized in the state of recording the second control program 221 in a portable information recording medium, similarly to the first control program 111.

The embodiment described above supports the following configurations.

(Configuration 1)

A control system which is a vehicle control system, including: a vehicle outside image acquisition unit configured to acquire a vehicle outside image which is an image outside the vehicle; a first detection unit configured to detect a vehicle outside person present outside the vehicle based on the vehicle outside image acquired by the vehicle outside image acquisition unit; a second detection unit configured to detect a predetermined motion of the vehicle outside person detected by the first detection unit; a first authentication unit configured to authenticate whether or not the vehicle outside person detected by the first detection unit is a registered user who is a user of the vehicle registered beforehand, based on a predetermined part of the vehicle outside person detected by the first detection unit; and a door control unit configured to perform door opening control regarding opening of a door of the vehicle, wherein the door control unit performs the door opening control in a first mode based on the predetermined motion detected by the second detection unit when the predetermined motion detected by the second detection unit is the predetermined motion of the vehicle outside person authenticated as the registered user by the first authentication unit.

According to the control system of configuration 1, since the door opening control is performed based on the predetermined motion of the vehicle outside person authenticated as the registered user, the door opening control is prevented from being performed by a predetermined motion of a third person. Thus, security of a vehicle can be improved while ensuring convenience of a user of the vehicle in the control of a door of the vehicle.

(Configuration 2)

The control system according to configuration 1, including a second authentication unit configured to authenticate whether or not the vehicle outside person detected by the first detection unit is the registered user, based on an approach mode to the vehicle of the vehicle outside person detected by the first detection unit, wherein the second detection unit detects the predetermined motion of the vehicle outside person authenticated as the registered user by the second authentication unit, the first authentication unit authenticates whether or not the vehicle outside person authenticated as the registered user by the second authentication unit is the registered user, based on a face of the vehicle outside person authenticated as the registered user by the second authentication unit, and the door control unit performs the door opening control at a timing of authentication by the first authentication unit when the first authentication unit authenticates that the vehicle outside person is the registered user in a state where the second detection unit detects the predetermined motion.

According to the control system of configuration 2, since the door opening control is performed based on the predetermined motion of the vehicle outside person authenticated as the registered user by two-factor authentication, the security of the vehicle can be improved more. In addition, by the configuration of detecting the predetermined motion before the authentication based on the face, the door opening control can be promptly performed after the authentication based on the face. Thus, the convenience of the user of the vehicle and the security of the vehicle can be improved more in the control of the door of the vehicle.

(Configuration 3)

The control system according to configuration 1 or configuration 2, wherein the door control unit performs the door opening control in a second mode based on the predetermined motion detected by the second detection unit when the first detection unit detects the plurality of vehicle outside persons including a non-registered user who is a user of the vehicle other than the registered user and the registered user.

According to the control system of configuration 3, since the mode of the door opening control can be made different according to whether or not the non-registered user is present with the registered user, the door opening control according to a user configuration of the vehicle can be performed. Thus, the convenience of the user of the vehicle can be improved more in the control of the door of the vehicle.

(Configuration 4)

The control system according to configuration 3, wherein the door control unit performs the door opening control based on the predetermined motion of the vehicle outside person authenticated as the registered user by the first authentication unit, and then performs the door opening control based on the predetermined motion of the non-registered user when the second detection unit detects the predetermined motion of the non-registered user.

According to the control system of configuration 4, after the door opening control by the predetermined motion of the registered user is performed, the non-registered user can make the vehicle perform the door opening control by the predetermined motion. Thus, the convenience of the user of the vehicle can be improved more while ensuring the security of the vehicle in the control of the door of the vehicle.

(Configuration 5)

The control system according to any one of configuration 2-configuration 4, wherein the predetermined motion is a gesture to the vehicle, the control system including a door opening control inhibition unit configured to make the door control unit inhibit execution of the door opening control when the gesture detected by the second detection unit is the gesture of covering a face with a hand.

According to the control system of configuration 5, by including the configuration of not performing the door opening control based on the predetermined motion, it is possible to respond to a situation where the user desires not to perform the door opening control, and the convenience of the user of the vehicle can be improved more. In addition, in the configuration of authenticating whether or not the vehicle outside person is the registered user by the face, by defining the gesture of covering the face with a hand as the gesture for not letting the door opening control be performed, the registered user can easily recognize what gesture is the gesture for not letting the door opening control be performed.

(Configuration 6)

The control system according to any one of configuration 1-configuration 5, wherein the door control unit performs the door opening control based on the predetermined motion of the vehicle outside person closest to a driver's seat of the vehicle when the second detection unit detects the plurality of predetermined motions and the plurality of predetermined motions detected by the second detection unit are the predetermined motions of each of the plurality of vehicle outside persons authenticated as the registered users by the first authentication unit.

According to the control system of configuration 6, since the predetermined motion of the vehicle outside person with high probability of being a driver of the vehicle can be given priority, the door opening control intended by the vehicle outside person can be performed. Thus, the convenience of the user of the vehicle can be improved more in the control of the door of the vehicle.

(Configuration 7)

The control system according to any one of configuration 1-configuration 6, including: a third detection unit configured to detect a get-off person who has gotten off the vehicle based on the vehicle outside image acquired by the vehicle outside image acquisition unit; and a fourth detection unit configured to detect a predetermined motion of the get-off person detected by the third detection unit, wherein the door control unit performs door closing control regarding closing of the door of the vehicle based on the predetermined motion detected by the fourth detection unit.

According to the control system of configuration 7, since the door closing control can be performed without the authentication when getting off from the vehicle, there is no need of deliberately turning back to perform the door closing control after getting off. Thus, the convenience of the user of the vehicle can be improved more in the control of the door of the vehicle.

(Configuration 8)

A control method of a control system which is a control method of a vehicle control system, including: acquiring a vehicle outside image which is an image outside the vehicle; detecting a vehicle outside person present outside the vehicle based on the acquired vehicle outside image; detecting a predetermined motion of the detected vehicle outside person; authenticating whether or not the detected vehicle outside person is a registered user who is a user of the vehicle registered beforehand, based on a predetermined part of the detected vehicle outside person; and performing door opening control regarding opening of a door of the vehicle in a first mode based on the detected predetermined motion when the detected predetermined motion is the predetermined motion of the vehicle outside person authenticated as the registered user.

According to the control method of the control system of configuration 8, effects similar to that of the control system of configuration 1 are accomplished.

1 . . . control system, 2 . . . central ECU, 3a . . . first communication line, 4c . . . second communication line, 5 . . . in-vehicle connection link, 7 . . . rear camera, 29 . . . zone A-ECU, 33 . . . door lock mechanism, 36 . . . entry ECU, 38 . . . front camera, 39 . . . right side camera, 40 . . . left side camera, 41A . . . driver's seat, 42 . . . door, 43 . . . camera (vehicle outside image acquisition unit), 100 . . . first processor, 101 . . . first communication control unit, 102 . . . door control unit, 110 . . . first memory, 111 . . . first control program, 200 . . . second processor, 201 . . . second communication control unit, 202 . . . registration unit, 203 . . . approach detection unit, 204 . . . vehicle outside person detection unit (first detection unit), 205 . . . approach mode authentication unit (second authentication unit), 206 . . . first gesture detection unit (second detection unit), 207 . . . face authentication unit (first authentication unit), 208 . . . get-off detection unit, 209 . . . get-off person detection unit (third detection unit), 210 . . . second gesture detection unit (fourth detection unit), 220 . . . second memory, 221 . . . second control program, 222 . . . approach mode DB, 223 . . . face DB, 224 . . . first gesture DB, 225 . . . second gesture DB, 226 . . . third gesture DB, V . . . vehicle, VP . . . vehicle outside person.

What is claimed is:

1. A control system which is a vehicle control system, comprising:
a vehicle outside image acquisition unit configured to acquire a vehicle outside image which is an image outside the vehicle;
a first detection unit configured to detect a vehicle outside person present outside the vehicle based on the vehicle outside image acquired by the vehicle outside image acquisition unit;
a second detection unit configured to detect a predetermined motion of the vehicle outside person detected by the first detection unit;
a first authentication unit configured to authenticate whether or not the vehicle outside person detected by the first detection unit is a registered user who is a user of the vehicle registered beforehand, based on a predetermined part of the vehicle outside person detected by the first detection unit; and
a door control unit configured to perform door opening control regarding opening of a door of the vehicle,
wherein the door control unit
performs the door opening control in a first mode based on the predetermined motion detected by the second detection unit when the predetermined motion detected by the second detection unit is the predetermined motion of the vehicle outside person authenticated as the registered user by the first authentication unit.

2. The control system according to claim 1, comprising
a second authentication unit configured to authenticate whether or not the vehicle outside person detected by the first detection unit is the registered user, based on an approach mode to the vehicle of the vehicle outside person detected by the first detection unit,
wherein the second detection unit detects the predetermined motion of the vehicle outside person authenticated as the registered user by the second authentication unit,
the first authentication unit authenticates whether or not the vehicle outside person authenticated as the registered user by the second authentication unit is the registered user, based on a face of the vehicle outside person authenticated as the registered user by the second authentication unit, and
the door control unit performs the door opening control at a timing of authentication by the first authentication unit when the first authentication unit authenticates that the vehicle outside person is the registered user in a state where the second detection unit detects the predetermined motion.

3. The control system according to claim 1,
wherein the door control unit
performs the door opening control in a second mode based on the predetermined motion detected by the second detection unit when the first detection unit detects the plurality of vehicle outside persons including a non-registered user who is a user of the vehicle other than the registered user and the registered user.

4. The control system according to claim 3,
wherein the door control unit
performs the door opening control based on the predetermined motion of the vehicle outside person authenticated as the registered user by the first authentication unit and then performs the door opening control based on the predetermined motion of the non-registered user when the second detection unit detects the predetermined motion of the non-registered user.

5. The control system according to claim 2,
wherein the predetermined motion is a gesture to the vehicle,
the control system comprising a door opening control inhibition unit configured to make the door control unit inhibit execution of the door opening control when the gesture detected by the second detection unit is the gesture of covering a face with a hand.

6. The control system according to claim 1,
wherein the door control unit
performs the door opening control based on the predetermined motion of the vehicle outside person located at a position closest to a driver's seat of the vehicle when the second detection unit detects the plurality of predetermined motions and the plurality of predetermined motions detected by the second detection unit are the predetermined motions of each of the plurality of vehicle outside persons authenticated as the registered users by the first authentication unit.

7. The control system according to claim 1, comprising:
a third detection unit configured to detect a get-off person who has gotten off the vehicle based on the vehicle outside image acquired by the vehicle outside image acquisition unit; and
a fourth detection unit configured to detect a predetermined motion of the get-off person detected by the third detection unit,
wherein the door control unit
performs door closing control regarding closing of the door of the vehicle based on the predetermined motion detected by the fourth detection unit.

8. A control method of a control system which is a control method of a vehicle control system, comprising:
acquiring a vehicle outside image which is an image outside the vehicle;
detecting a vehicle outside person present outside the vehicle based on the acquired vehicle outside image;
detecting a predetermined motion of the detected vehicle outside person;
authenticating whether or not the detected vehicle outside person is a registered user who is a user of the vehicle registered beforehand, based on a predetermined part of the detected vehicle outside person; and
performing door opening control regarding opening of a door of the vehicle in a first mode based on the detected predetermined motion when the detected predetermined motion is the predetermined motion of the vehicle outside person authenticated as the registered user.
